(19) United States
(12) Patent Application Publication
(10) Pub. No.: US 2013/0313969 A1
(43) Pub. Date: Nov. 28, 2013

(54) PLASMA DISPLAY PANEL

(71) Applicants: Kaname Mizokami, Kyoto (JP); Koyo Sakamoto, Osaka (JP); Yoshiyuki Hisatomi, Shiga (JP); Yoshinao Ooe, Kyoto (JP)

(72) Inventors: Kaname Mizokami, Kyoto (JP); Koyo Sakamoto, Osaka (JP); Yoshiyuki Hisatomi, Shiga (JP); Yoshinao Ooe, Kyoto (JP)

(73) Assignee: PANASONIC CORPORATION, Osaka (JP)

(21) Appl. No.: 13/984,252

(22) PCT Filed: Mar. 5, 2012
(86) PCT No.: PCT/JP2012/001491

§ 371 Date: Aug. 7, 2013

(30) Foreign Application Priority Data
Apr. 15, 2011 (JP) 2011-090784

(51) Int. Cl. H01J 11/40

(52) U.S. Cl. CPC H01J 11/40
USPC 313/587

(57) ABSTRACT

A plasma display panel includes a front plate and a rear plate provided to be opposed to the front plate. The front plate includes a display electrode, a dielectric layer for covering the display electrode, and a protective layer for covering the dielectric layer. The protective layer includes a base layer, and a metal oxide formed on the base layer. The metal oxide has a ratio from 0.1 to 10 inclusive between the maximum intensity of photoluminescence at a wavelength ranging from 200 nm to less than 300 nm and the maximum intensity of photoluminescence at a wavelength ranging from 300 nm to less than 500 nm. Furthermore, the metal oxide contains aluminum from 50 ppm to 200 ppm inclusive in terms of weight concentration, and fluorine from 150 ppm to 600 ppm inclusive in terms of weight concentration.

### TECHNICAL FIELD

The technique disclosed herein relates to a plasma display panel for use in a display device or the like.

### BACKGROUND ART

One of the functions of protective layers of plasma display panels (hereinafter, referred to as PDPs) is emitting initial electrons for generating address discharge. In order to reduce address discharge errors, techniques are known for protective layers including magnesium oxide crystal particles (for example, see Patent Document 1).

### Citation List

### Patent Literature

### PTL 1: Unexamined Japanese Patent Publication No. 2006-134735

### SUMMARY OF THE INVENTION

A PDP includes a front plate and a rear plate placed to be opposed to the front plate. The front plate includes a display electrode, a dielectric layer for covering the display electrode, and a protective layer for covering the dielectric layer. The protective layer includes a base layer, and a metal oxide formed on the base layer. The metal oxide has a ratio from 0.1 to 10 inclusive between the maximum intensity of photoluminescence at a wavelength ranging from 200 nm to less than 300 nm and the maximum intensity of photoluminescence at a wavelength ranging from 300 nm to less than 500 nm. The metal oxide contains aluminum from 50 ppm to 200 ppm inclusive in terms of weight concentration, and fluorine from 150 ppm to 600 ppm inclusive in terms of weight concentration.

### BRIEF DESCRIPTION OF DRAWINGS

FIG. 1 is a perspective view illustrating the structure of a PDP according to the present embodiment.

FIG. 2 is a schematic cross-sectional view illustrating the structure of a front plate according to the present embodiment.

FIG. 3 is a flowchart showing a method for forming a protective layer according to the present embodiment.

FIG. 4 is a diagram showing the relationship between an aluminum concentration and discharge delay time.

FIG. 5 is a diagram showing the relationship between an aluminum concentration and an increase rate of statistic delay time.

FIG. 6 is a diagram showing the relationship between a fluorine concentration and an increase rate of statistic delay time.

FIG. 7 is a diagram showing the relationship between a fluorine concentration and a particle size.

FIG. 8 is a diagram showing a photoluminescence waveform.

FIG. 9 is a diagram showing the relationship between photoluminescence characteristics and the amount of charge through.

FIG. 10 is a diagram illustrating driving waveforms of a PDP.

### DESCRIPTION OF EMBODIMENT

### 1. Configuration of PDP 1

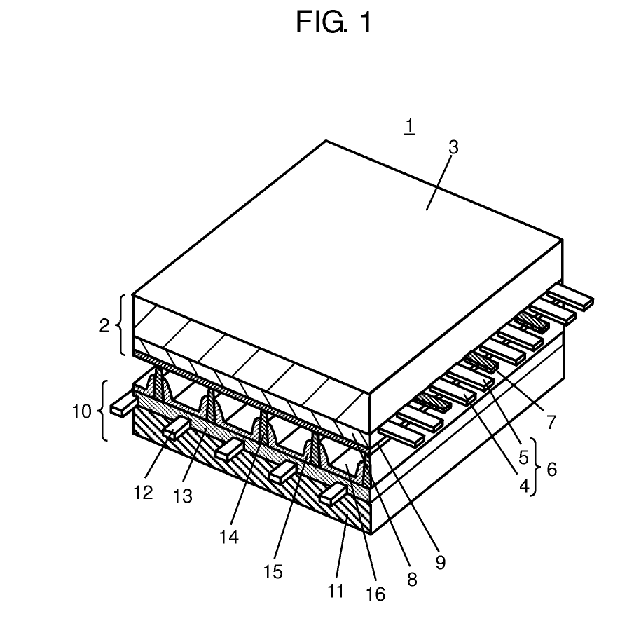

PDP 1 according to the present embodiment is a alternating-current surface-discharge type PDP. As shown in FIG. 1, PDP 1 has front plate 2 including front glass substrate 3, and rear plate 10 including rear glass substrate 11, front plate 2 and rear plate 10 provided to be opposed to each other. Front plate 2 and rear plate 10 have an outer periphery hermetically sealed with a sealing material including glass frit. Discharge space 16 in sealed PDP 1 is filled with a discharge gas such as neon (Ne) and xenon (Xe) at a pressure from 55 kPa to 80 kPa.

As an example, pairs of display electrodes 6 each including scan electrode 4 and sustain electrode 5 are arranged in rows on front glass substrate 3. In addition, black stripes 7 are arranged in rows. On front glass substrate 3, dielectric layer 8 is provided which covers display electrodes 6. Dielectric layer 8 serves as a capacitor. Furthermore, protective layer 9 including a magnesium oxide (MgO) is formed on dielectric layer 8.

Further, a transparent electrode may be formed between scan electrodes 4 and sustain electrode 5 and front glass substrate 3

On rear glass substrate 11, a plurality of address electrode 12 are arranged which extend in a direction orthogonal to display electrodes 6. The plurality of address electrode 12 are parallel to each other. Furthermore, insulating layer 13 is provided which coats address electrodes 12. Barrier ribs 14 with a predetermined height are provided on insulating layer 13. Barrier ribs 14 partition discharge space 16. Phosphor layers 15 which emit red, blue, or green light under ultraviolet light are formed between barrier ribs 14.

Discharge cells are formed in positions in which display electrodes 6 cross address electrodes 12. One pixel has a discharge cell for emitting red light, a discharge cell for emitting blue light, and a discharge cell for emitting green light. The plurality of pixels achieve color display.

2. Method for Manufacturing PDP 1

2-1. Method for Manufacturing Front Plate 2

Scan electrodes 4 and sustain electrodes 5, as well as black stripes 7 are formed on front glass substrate 3 by a photolithographic method. Scan electrodes 4 and sustain electrodes 5 include white electrodes 4b, 5b containing silver (Ag) for achieving favorable conductivity. In addition, scan electrodes 4 and sustain electrodes 5 include black electrodes 4a, 5a containing a black pigment for improving the contrast on the image display surface. While electrodes 4b are stacked on black electrodes 4a. While electrodes 5b are stacked on black electrodes 5a.

For the material of black electrodes 4a, 5a, a black paste is used which contains a black pigment for ensuring the degree of blackness, glass frit for binding the black pigment, a photosensitive resin, a solvent, etc. First, the black paste is applied onto front glass substrate 3 by a screen printing method or the like. Next, the solvent in the black paste is removed in a baking oven. Next, the black paste is exposed to light through a photomask in a predetermined pattern.

For the material of white electrodes 4b, 5b, a white paste is used which contains silver (Ag), glass frit for binding the silver (Ag), a photosensitive resin, a solvent, etc. First, the white paste is applied onto front glass substrate 3 with the black paste formed, by a screen printing method or the like. Next, the solvent in the white paste is removed in a baking oven. Next, the white paste is exposed to light through a photomask in a predetermined pattern.

Next, the black paste and the white paste are developed respectively to form a black electrode pattern and a white electrode pattern. Finally, the black electrode pattern and the white electrode pattern are subjected to firing at a predetermined temperature in a firing oven. More specifically, the photosensitive resin in the black electrode pattern and the photosensitive resin in the white electrode pattern are removed. In addition, the glass frit in the black electrode pattern is melted. The melted glass frit is vitrified again after the firing. In addition, the glass frit in the white electrode pattern is melted. The melted glass frit is vitrified again after the firing. Black electrodes 4a, 5a and white electrodes 4b, 5b are formed in accordance with the step described above.

Black stripes 7 are formed in the same way as black electrodes 4a, 5a. It is to be noted that black stripes 7 may be formed at the same time as black electrodes 4a, 5a. In this case, besides the method of screen printing with the black electrode paste and the white electrode paste, a sputtering method, a vapor deposition method, and the like can be used.

Next, dielectric layer 8 is formed. For the material of dielectric layer 8, a dielectric paste is used which contains dielectric glass frit, a resin, a solvent, etc. First, the dielectric paste is applied for a predetermined thickness onto front glass substrate 3 by a die coating method, so as to cover scan electrodes 4, sustain electrode 5, and black stripes 7. Next, the solvent in the dielectric paste is removed in a baking oven. Finally, the dielectric paste is subjected to firing at a predetermined temperature in a firing oven. More specifically, the resin in the dielectric paste is removed. In addition, the dielectric glass frit is melted. The melted dielectric glass frit is vitrified again after the firing. In accordance with the step described above, dielectric layer 8 is formed. In this case, besides the method of die coating with the dielectric paste, a screen printing method, a spin coating method, and the like can be used. Alternatively, a film to serve as dielectric layer 8 can be also formed by a CVD (Chemical Vapor Deposition) method or the like, without using the dielectric paste.

Next, protective layer 9 is formed on dielectric layer 8. Protective layer 9 will be described in detail later.

In accordance with the steps described above, front plate 2 including scan electrodes 4, sustain electrodes 5, black stripes 7, dielectric layer 8, and protective layer 9 is formed on front glass substrate 3.

### 2-2. Method for Manufacturing Rear Plate 10

Address electrodes 12 are formed on rear glass substrate 11 by a photolithographic method. For the material of the address electrodes, a address electrode paste is used which contains silver (Ag) for achieving favorable conductivity, glass frit for binding the silver (Ag), a photosensitive resin, a solvent, etc. First, the address electrode paste is applied for a predetermined thickness onto rear glass substrate 11 by a screen printing method or the like. Next, the solvent in the address electrode paste is removed in a baking oven. Next, the address electrode paste is exposed to light through a photomask in a predetermined pattern. Next, the address electrode paste is developed to form an address electrode pattern. Finally, the address electrode pattern is subjected to firing at a predetermined temperature in a firing oven. More specifically, the photosensitive resin in the address electrode pattern is removed. In addition, the glass frit in the address electrode pattern is melted. The melted glass frit is vitrified again after the firing. In accordance with the step described above, address electrodes 12 are formed. In this case, besides the method of screen printing with the address electrode paste, a sputtering method, a vapor deposition method, and the like can be used.

Next, insulating layer 13 is formed. For the material of insulating layer 13, an insulating paste is used which contains dielectric glass frit, a resin, a solvent, etc. First, the insulating paste is applied for a predetermined thickness onto rear glass substrate 11 with address electrodes 12 formed by a screen printing method or the like, so as to cover address electrodes 12. Next, the solvent in the insulating paste is removed in a baking oven. Finally, the insulating paste is subjected to firing at a predetermined temperature in a firing oven. More specifically, the resin in the insulating paste is removed. In addition, the dielectric glass frit is melted. The melted dielectric glass frit is vitrified again after the firing. In accordance with the step described above, insulating layer 13 is formed. In this case, besides the method of screen printing with the insulating paste, a die coating method, a spin coating method, and the like can be used. Alternatively, a film to serve as insulating layer 13 can be also formed by a CVD (Chemical Vapor Deposition) method or the like, without using the insulating paste.

Next, barrier ribs 14 are formed by a photolithographic method. For the material of barrier ribs 14, a barrier rib paste is used which contains a filler, glass frit for binding the filler, a photosensitive resin, a solvent, etc. First, the barrier rib paste is applied for a predetermined thickness onto insulating layer 13 by a die coating method or the like. Next, the solvent in the barrier rib paste is removed in a baking oven. Next, the barrier rib paste is exposed to light through a photomask in a predetermined pattern. Next, the barrier rib paste is developed to form a barrier rib pattern. Finally, the barrier rib pattern is subjected to firing at a predetermined temperature in a firing oven. More specifically, the photosensitive resin in the barrier rib pattern is removed. In addition, the glass frit in the barrier rib pattern is melted. The melted glass frit is vitrified again after the firing. In accordance with the step described above, barrier ribs 14 are formed. In this case, besides the photolithographic method, a sandblasting method and the like can be used.

Next, phosphor layers 15 are formed. For the material of phosphor layers 15, a phosphor paste is used which contains phosphor particles, a binder, a solvent, etc. First, the phosphor paste is applied for a predetermined thickness by a dispensing method or the like onto insulating layer 13 between adjacent barrier ribs 14 and onto the side surfaces of barrier ribs 14. Next, the solvent in the phosphor paste is removed in a baking oven. Finally, the phosphor paste is subjected to firing at a predetermined temperature in a firing oven. More specifically, the resin in the phosphor paste is removed. In accordance with the step described above, phosphor layers 15 are formed. In addition, besides the dispensing method, a screen printing method and the like can be used.

In accordance with the steps described above, rear plate 10 is completed which includes address electrodes 12, insulating layer 13, barrier ribs 14, and phosphor layers 15 on rear glass substrate 11.

### 2-3. Method for Assembly of Front Plate 2 and Rear Plate 10

First, a sealing material (not shown) is formed around rear plate 10 by a dispensing method. For the material of the sealing material (not shown), a sealing paste is used which contains glass frit, a binder, a solvent, etc. Next, the solvent in the sealing paste is removed in a baking oven. Next, front plate 2 and rear plate 10 are placed in an opposed fashion so that display electrodes 6 are orthogonal to address electrodes 12. Next, front plate 2 and rear plate 10 have an outer periphery hermetically sealed with glass frit. Finally, discharge space 16 is filled with a discharge gas containing Ne or Xe. In accordance with the steps described above, PDP 1 is completed.

### 3. Detail of Protective Layer 9

Conventionally, protective layer 9 may have the conflicting abilities to emit initial electrons and keep electrical charges in some cases. The decreased ability to keep electric charges will increase the voltage required for address discharge.

The technique disclosed herein makes it possible to suppress the increase in voltage required for address discharge while reducing address discharge errors.

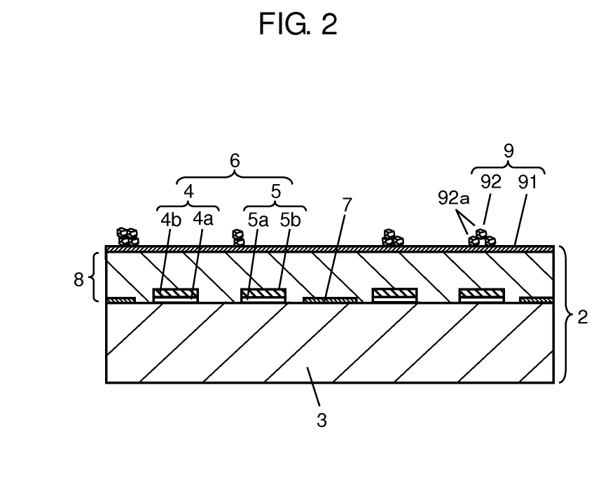

As shown in FIG. 2, protective layer 9 includes base film 91 and metal oxide crystal particles 92a. Base film 91 is, as an example, a magnesium oxide (MgO) film containing aluminum (Al) as an impurity. Metal oxide crystal particles 92a are, as an example, MgO crystal particles. In addition, in the present example, more than one aggregated particle 92 of more than one metal oxide crystal particle 92a aggregated is attached over the entire surface of base film 91 so as to be distributed uniformly.

### 3-1. Detail of Aggregated Particle 92

At the start of address discharge, initial electrons to serve as a trigger are emitted from the surface of protective layer 9 into discharge space 16. The lack of initial electrodes is considered as a major cause of discharge delay. Aggregated particles 92 mainly have the effect of suppressing the discharge delay in address discharge, and the effect of improving temperature dependence of the discharge delay. More specifically, aggregated particles 92 have a high ability to emit initial electrons. Therefore, in the present embodiment, aggregated particles 92 are provided as an initial electron supply section required for discharge pulse rise. Aggregated particles 92 makes abundant initial electrons present in discharge space 16 at the discharge pulse rise. Therefore, PDP 1 which has higher definition can be driven at high speed with discharge delay suppressed, even when the time allotted for address discharge is reduced.

Aggregated particle 92 refers to more than one aggregated metal oxide crystal particle 92a with a predetermined primary particle size. Aggregated particle 92 has no bonds made by any strong bonding force as a solid. Aggregated particle 92 has a number of primary particles gathered by static electricity or van der Waals' force. In addition, aggregated particle 92 has bonds made by such a force as to be partially or entirely decomposed into primary particles by an external force such as ultrasonic waves. Metal oxide crystal particles 92a desirably have a polyhedron shape with seven or more faces, such as a tetradecahedron or a dodecahedron.

### 3-2. Method for Preparing MgO Crystal Particle

The method according to the present embodiment is based on a thermal decomposition process. Specifically, a MgO precursor having a hydroxyl group or a carbonic acid group (hereinafter, referred to as a precursor) is subjected to firing in a firing furnace or the like. The hydroxyl group or carbonic acid of the precursor is removed by heat to prepare MgO coarse particles as metal oxide coarse particles. The MgO coarse particle refers to a large number of primary particles of MgO crystal as metal oxide crystal. Next, the MgO coarse particles are subjected to grinding by a jet mill or the like. MgO crystal particles that are small average particle size are prepared by the grinding.

It is to be noted that the precursor is produced by a liquid phase method. Therefore, the precursor itself is an aggregate of primary particles. In addition, the type of the precursor is not particularly limited. For example, magnesium hydroxide, basic magnesium carbonate, magnesium carbonate, magnesium oxalate, and the like can be used.

In addition, if the precursor contains a lot of impurities, unintended impurities may be mixed into prepared MgO crystal particles in some cases. The precursor preferably contains fewer impurities, because the MgO crystal particles may vary in property in some cases. As the impurity amount specifically contained in the precursor, the total amount of residual impurities in the production of MgO crystal particles by a thermal decomposition method is preferably 0.1 weight % or less, and more preferably 0.01 weight % or less.

An air furnace or the like is used for the firing furnace. The firing is carried out in an opened condition under an atmosphere such as air or oxygen. Alternatively, the firing may be carried out while flowing air or oxygen. The firing temperature preferably ranges from 700° C. to 1500° C. Furthermore, the firing temperature is most preferably on the order of 1200 ° C. The firing time ranges from approximately 1 hour to 10 hours, depending on the firing temperature. For example, the firing time of approximately 5 hours is appropriate when the firing temperature is approximately 1200° C. The rate of temperature increase in the firing furnace is not particularly limited. The rate of temperature increase preferably ranges, for example, from 5° C./mm to 10° C./mm. The atmosphere for the firing is not particularly limited. For example, air, oxygen, nitrogen, argon, etc. are used for the atmosphere for the firing. It is to be noted that the use of an oxidizing atmosphere makes it possible to remove impurities contained in the precursor, as oxidized gas. Therefore, the atmosphere for the firing is preferably air or oxygen.

In accordance with the step described above, the MgO coarse particles are prepared. The average particle size for the MgO coarse particles ranges from 1.0 nm to 4.0 nm. It is to be noted that the average particle size refers to a volume cumulative mean diameter (D50) in the present embodiment. In addition, a laser-diffraction particle size distribution measuring system MT-3300 (from Nikkiso Co., Ltd.) is used for the measurement of the average particle size. The use of the MgO coarse particles directly for protective layer 9 may cause trouble in the manufacturing system in some cases. Moreover, barrier ribs 14 may be destroyed in some cases in the assembly of front plate 2 and rear plate 10. Therefore, the MgO coarse particles are preferably subjected to grinding so as to reduce the average particle size.

It is to be noted that the grinding in the present embodiment refers to loosening metal oxide coarse particles of a large number of aggregated primary particles to a metal oxide with a predetermined average particle size. Therefore, the average particle size of the metal oxide may vary from the size of a primary particle of metal oxide crystal to the size of a number of aggregated primary particles of metal oxide crystal. It is to be noted that the primary particle of metal oxide crystal has a particle size hardly changed by the grinding.

Next, the MgO coarse particles are subjected to grinding by a jet mill. The jet mill has a cylindrical chamber. The chamber has a plurality of grinding nozzles arranged. From the grinding nozzles, compressed air is introduced into the chamber. Therefore, the MgO coarse particles are ground by collision with each other. Furthermore, the jet mill is provided with a classifier. Therefore, MgO crystal particles of a predetermined particle size can be extracted.

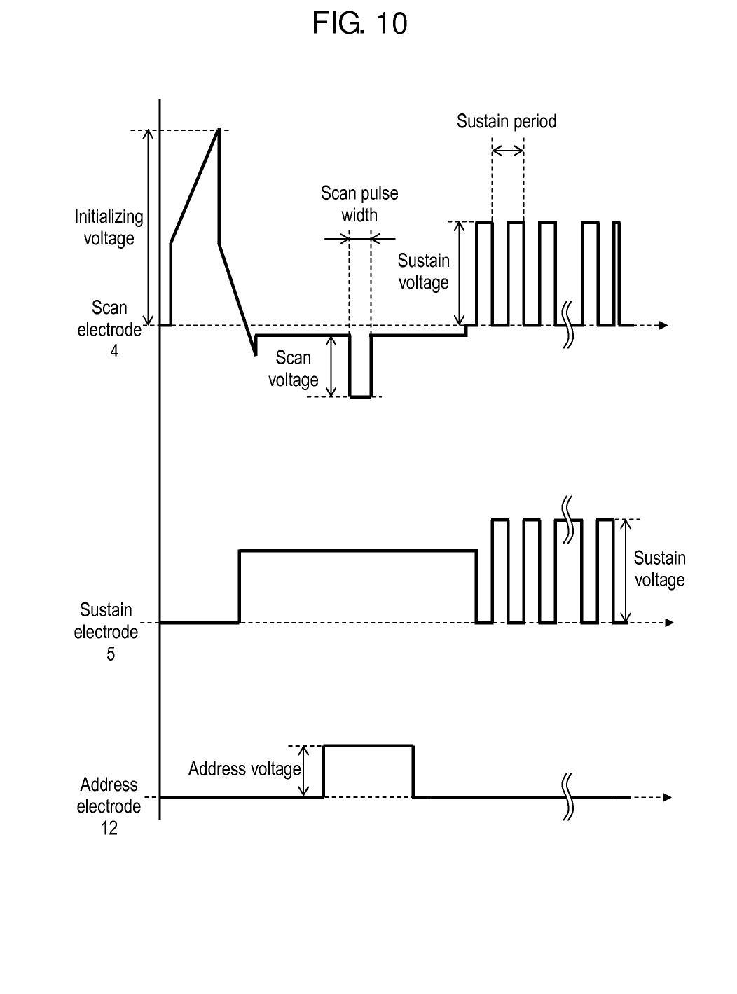

In the present embodiment, a jet mill is used which includes a chamber of 160 mm in diameter and 140 mm in height. The air from 0.2 m³ to 0.3 m³ per minute is introduced into the chamber. For the introduction of the air, the pressure is adjusted in the range of 0.2 MPa to 0.4 MPa. It is to be noted that nitrogen may be used instead of the air. This is because the deficient oxygen amount, etc. of the MgO coarse particles are not varied, due to no oxygen contained. Finally, the MgO crystal particles have an average particle size ranging from 0.3 nm to 2 nm. Typically, PDP 1 lights up by sub-field driving as shown in FIG. 10.

In the sub-field driving, one field is separated into an initializing period, an address period, and a sustain period. Regardless of the presence or absence of sustain discharge, initializing discharge is carried out in the initializing period, because the presence or absence of sustain discharge is determined in the address period. Therefore, it is effective to reduce the number of initializing discharge times, for example, initializing discharge once for every several fields, in order to improve the contrast when PDP 1 lights up. However, there is concern that wall charges will be insufficiently accumulated only by simply reducing the number of initializing discharge times.

### 3-3. Additive Element

The inventors have clarified the influence of an additive element on aggregated particles 92 by using the method described in Unexamined Japanese Patent Publication No. 2007-48733. Measured are the delay time in address discharge (discharge delay time) and the numerical value as an indication of how easily discharge is generated (statistic delay time). As the statistic delay time is reduced, discharge is more likely to be generated. The discharge delay time refers to the time from the rise of an address discharge pulse to the delayed generation of address discharge. As a major factor for the generation of delayed discharge, it is considered that initial electrons to serve as a trigger when address discharge is generated are less likely to be emitted from the surface of the protective layer into the discharge space.

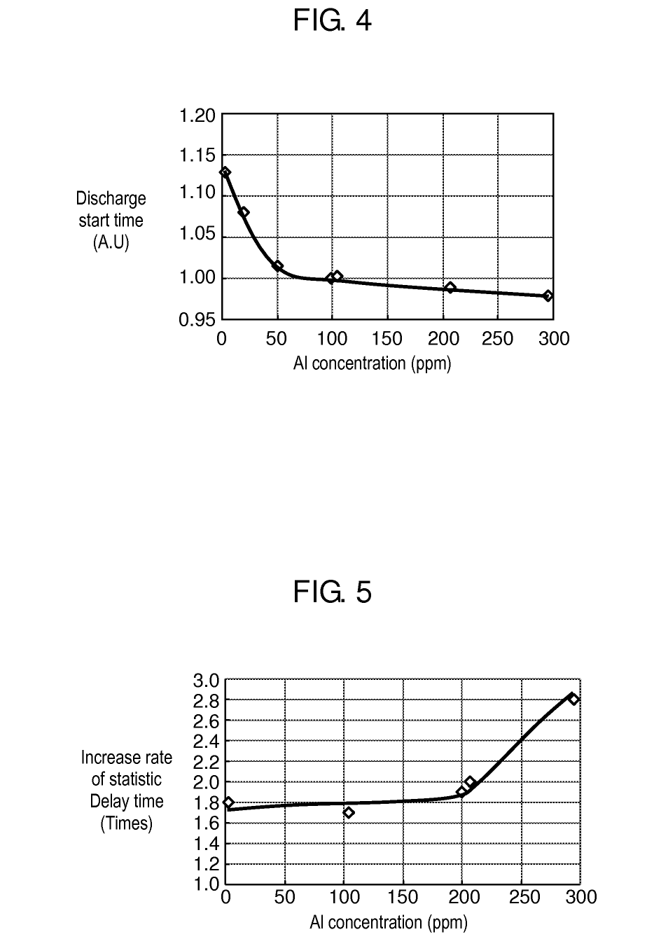

Aggregated particles 92 preferably contain aluminum (Al). This is because containing aluminum (Al) makes a contribution to the wall charge accumulation. Hereinafter, unless otherwise indicated, the “concentration” means the “weight concentration”. As shown in FIG. 4, the discharge delay time is sharply increased, as the concentration of aluminum (Al) in aggregated particles 92 is lower than 50 ppm. It is to be noted that the discharge delay time in FIG. 4 refers to the time to the earliest generation of address discharge when address discharge is generated more than once. More specifically, the discharge delay time in FIG. 4 is a value reflected by the amount of wall charge formation.

On the other hand, if the concentration of aluminum (Al) is excessively increased, the crystal growth of metal oxide crystal particles 92a may be hindered in some cases. As a result, there is a possibility of deterioration in crystallinity of metal oxide crystal particles 92a. When the crystallinity is deteriorated, an unnecessary level is formed in the bandgap. As shown in FIG. 5, it has been determined that the increase rate of statistic delay time is increased when the concentration of aluminum (Al) exceeds 200 ppm. It is to be noted that the increase rate of statistic delay time in FIG. 5 is derived from the statistic delay time in the case of generating initializing discharge for even 6 fields, while the statistic delay time is regarded as 1 in the case of generating initializing discharge for every field.

Therefore, the concentration of aluminum (Al) in aggregated particles 92 preferably ranges from 50 ppm to 200 ppm inclusive.

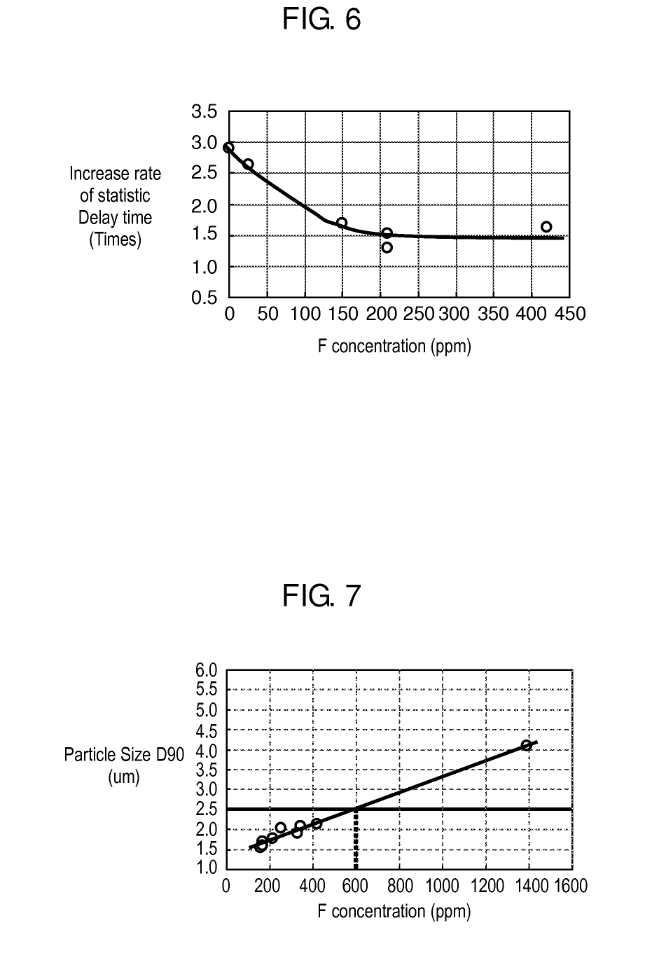

Moreover, the statistic delay time may be also increased depending on the cumulative lighting time of PDP 1 in some cases. Thus, aggregated particles 92 preferably contain fluorine (F). This is because containing fluorine (F) suppresses the increase in statistic delay time. As shown in FIG. 6, when the concentration of fluorine (F) in aggregated particles 92 reaches 150 ppm more, the increase rate of statistic delay time is decreased. It is to be noted that the increase rate of statistic delay time is derived from the statistic delay time after lighting up for 2000 hours while the statistic delay time is regarded as 1 when PDP 1 initially lights up. The addition of fluorine (F) promotes the crystal growth of metal oxide crystal particles 92a. Thus, the crystallinity of metal oxide crystal particles 92a is considered to be increased. The improvement in sputtering-resistance performance during discharge in aggregated particles 92 is considered to suppress the increase rate of statistic delay time.

On the other hand, it has been determined that the particle sizes of aggregated particles 92 are increased when the fluorine (F) concentration is excessively increased. More specifically, the excessively increased fluorine (F) concentration means the increased number of metal oxide crystal particles 92a constituting aggregated particles 92. The increased particle sizes of aggregated particles 92 increases the probability causing damage to barrier ribs 14 when front plate 2 and rear plate 10 are placed in an opposed fashion. As shown in FIG. 7, it has been determined that the particles size (D90) for aggregated particles 92 exceed 2.5 nm as a specified value when the fluorine (F) concentration in aggregated particles 92 exceeds 600 ppm. When the particle size exceeds the specified value, the probability of causing damage to barrier ribs 14 is significantly increased.

Therefore, the concentration of fluorine (F) in aggregated particles 92 preferably ranges from 150 ppm to 600 ppm inclusive.

However, at this rate, the statistic delay time is an excessively small amount of time, and the charges once accumulated are thus released. More specifically, the phenomenon referred to as charge through may be caused in some cases. When the charge through is caused, trouble will be caused such as that the cell to light up fails to light up.

3-4. Photoluminescence Evaluation The inventors have found that the charge through can be suppressed when the photoluminescence waveform for aggregated particles 92 falls within a predetermined range.

The emission intensity of photoluminescence is measured for MgO crystal particles as metal oxide crystal particles 92a. The photoluminescence measurement is carried out under the following conditions. An excimer lamp with an emission wavelength of 146 nm (from USHIO, Inc.) is used for a light source. The excimer lamp is placed in a position of 100 nm above a sample. The pressure in a vacuum chamber is kept at 1×10⁻² Pa by a turbo-molecular pump. A built-in CCD spectroscope in a wavelength range from 200 nm to 800 nm (from Hamamatsu Photonics K.K.) is used for a detector. The photoluminescence is considered to be generated from almost the surface of the sample, because the wavelength of incident light is 146 nm.

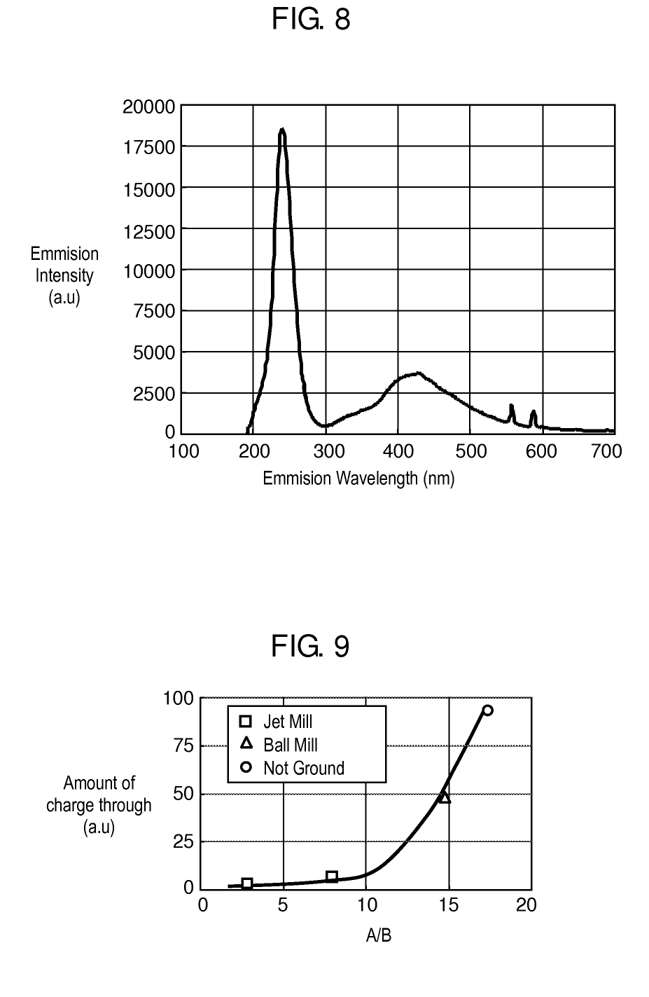

As shown in FIG. 8, the MgO crystal particles produce luminescence with a peak at a wavelength in the range from 200 nm to 300 nm.

Furthermore, the MgO crystal particles produce luminescence with a peak at a wavelength in the range from 300 nm to 500 nm.

The luminescence at a wavelength in the range from 200 nm to 300 nm means that the MgO crystal particles have an energy level corresponding to the luminescence at a wavelength from 200 nm to 300 nm. The energy level is considered to be able to capture electrons generated during initializing discharge for a long period of time (several msec or more). When an address voltage is applied during address discharge, an electric field is formed in protective layer 9. The electrons captured at the energy level are removed by heat and the electric field into the discharge space. When the initial electrons required for the start of address discharge are quickly and sufficiently obtained, the discharge start time is earlier. As described above, the increased emission intensity at a wavelength from 200 nm to 300 nm is considered to shorten the statistic delay time.

On the other hand, the luminescence at a wavelength from 300 nm to 500 nm is considered to indicate the existence of deficient oxygen. The increased emission intensity is considered to also increase deficient oxygen. The ability to emit initial electrons is decreased while the ability to keep charges is improved, because electrons captured at an electron emission level near the surface of the MgO crystal particles drop to a deep energy level caused by the deficient oxygen. More specifically, the increased emission intensity at a wavelength from 300 nm to 500 nm can suppress the amount of electron through.

In the case of defining the maximum value of the emission intensity at a wavelength from 200 nm to 300 nm as A, and defining the maximum value of the emission intensity at a wavelength from 300 nm to 500 nm as B, it is determined that when the A/B of A divided by B exceeds 10, the amount of charge through is rapidly increased as shown in FIG. 9. On the other hand, when the A/B is less than 0.1, initial electrons are emitted insufficiently. Therefore, the A/B preferably ranges from 0.1 to 10 inclusive. Furthermore, from the perspective of initial electron emission, the A/B is preferably 2 or more. It is to be noted that the photoluminescence measurement is carried out for four levels of samples in FIG. 9. The samples are: two samples subjected to grinding by a jet mill; a sample subjected to grinding by a ball mill; and a sample subjected to no grinding. The two samples in the case of the jet mill are a sample for which the pressure of introduced air is relatively high and sample for which the pressure is relatively low. When the pressure of the introduced air is relatively low, the A/B is 7.6. When the pressure of the introduced air is relatively high, the A/B is 3.7. From FIG. 9, it is determined that the magnesium oxide crystal particles subjected to grinding by the jet mill exhibits favorable characteristics.

### 3-5. Method for Forming Protective Layer 9

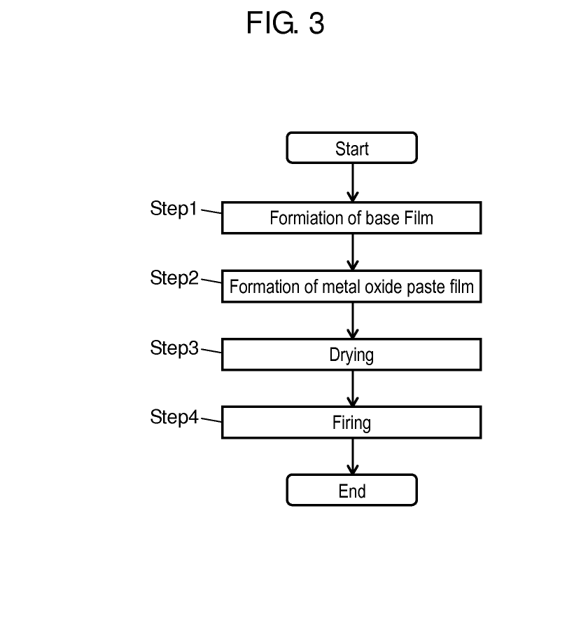

As shown in FIG. 3, the formation of protective layer 9 is started after the formation of dielectric layer 8. First, base film 91 is formed in step 1. For the material, for example, a MgO sintered body is used which contains aluminum (Al). For the method, for example, a vacuum vapor deposition method is used. Specifically, a raw material is irradiated with electron beams in a vacuum chamber to allow the raw material to vaporize and deposit the raw material on dielectric layer 8. Base film 91 mainly including MgO is formed on dielectric layer 8. Base film 91 has a film thickness, as an example, from approximately 500 nm to 1000 nm.

In step 2, a metal oxide paste film is formed. For the material, for example, a metal oxide paste is used which is obtained by kneading aggregated particles 92 of a number of aggregated MgO crystal particles along with an organic resin component and a diluted solvent. For the method, for example, a screen printing method is used. Specifically, the metal oxide paste is applied over the entire surface of base film 91 to form a metal oxide paste film. The metal oxide paste film has a film thickness, as an example, from approximately 5 nm to 20 nm. It is to be noted that besides the screen printing method, a spray method, a spin coating method, a die coating method, a slit coating method, and the like can be also used as the method for forming the metal oxide paste film on the base film.

In step 3, the metal oxide paste film is dried. The metal oxide paste film is heated at a predetermined temperature in a baking oven or the like. The temperature range is, as an example, from 100° C. to 150° C. The heating removes the solvent component from the metal oxide paste film.

In step 4, the dried metal oxide paste film is subjected to firing. The metal oxide paste film is heated at a predetermined temperature in a firing furnace or the like. The temperature range is, as an example, from 400° C. to 500° C. The atmosphere for the firing is not particularly limited.

For example, air, oxygen, nitrogen, etc. are used. The heating removes the resin component from the metal oxide paste film.

In accordance with the step described above, aggregated particles 92 are discretely deposited on base film 91.

### 4. Example

Multiple PDPs 1 were prepared. In addition, the prepared PDPs 1 were evaluated for performance. The prepared PDPs 1 are appropriate to 42-inch classes of high-definition televisions. PDP 1 includes front plate 2 and rear plate 10 placed to be opposed to front plate 2. In addition, front plate 2 and rear plate 10 have a periphery hermetically sealed with a sealing material. Front plate 2 includes display electrodes 6, dielectric layer 8, and protective layer 9. Rear plate 10 includes address electrodes 12, insulating layer 13, barrier ribs 14, and phosphor layers 15. PDPs 1 were filled, at an internal pressure of 60 kPa, with a Ne—Xe mixed gas in which the Xe content was 15 volume %. In addition, the interelectrode distance between display electrodes 6 was 0.06 mm. Barrier ribs 14 were 0.15 mm in height, and the distance (cell pitch) between barrier ribs 14 was 0.15 mm.

Aggregated particles 92 of a number of aggregated MgO crystal particles subjected to grinding by a jet mill were used for the example. The condition that the pressure of introduced air was relatively high was applied to the jet mill. Aggregated particles 92 in the example have photoluminescence characteristics with the A/B of 3.7. The particle size distributions of aggregated particles 92 in the example were 0.5 μm (D10), 1.2 μm (D50), and 2.1 μm(D90).

It is to be noted that the particle size distributions of the MgO coarse particles before the grinding were 0.6 μm (D10), 1.9 μm (D50), 3.7 μm (D90).

On the other hand, aggregated particles 92 of a number of aggregated MgO crystal particles subjected to grinding by a ball mill were used for a comparative example. Aggregated particles 92 in the comparative example have photoluminescence characteristics equivalent to those of the sample subjected to grinding by the ball mill as shown in FIG. 9.

Aggregated particles 92 in the example and comparative example were 1.1 μm in average particle size. Furthermore, aggregated particles 92 in the example and comparative example were 150 ppm in aluminum (Al) concentration and 400 ppm in fluorine (F) concentration. Aggregated particles 92 in the example and comparative example were 8% in coverage.

The coverage is represented by the ratio of the area a of aggregated particles 92 deposited to the area b of one discharge cell, in the region of one discharge cell. More specifically, the coverage is calculated by the formula: Coverage (%) =a/b×100. As the measurement method, for example, a region including the region corresponding to one discharge cell partitioned by barrier ribs 14 is imaged with a camera. Next, the image obtained by the imaging is subjected to trimming into the size of one discharge cell.

Next, the image subjected to the trimming is binarized into black and white data. Next, the area a of the black area occupied by aggregated particles 92 is calculated on the basis of the binarized data. Finally, the coverage (%) is calculated by the formula: a/b×100.

The difference in method for manufacturing PDP 1 between the example and the comparative example is only the method for grinding the MgO coarse particles.

The inventors activated PDPs 1 to light up by a sub-field driving method with the reduced number of initializing discharge times to evaluate the discharge characteristics. The example has succeeded in suppressing the increase in voltage required for discharge while reducing address discharge errors. More specifically, the example has succeeded in achieving a balance between two characteristics of statistic delay time and charge through. On the other hand, the comparative example has succeeded in reducing address discharge errors, while the voltage required for discharge is increased more than in the example. More specifically, the comparative example has failed to achieve a balance between two characteristics of statistic delay time and charge through.

5. Conclusion PDP 1 according to the present embodiment includes front plate 2, and rear plate 10 provided to be opposed to front plate 2. Front plate 2 includes display electrodes 6, dielectric layer 8 for covering display electrodes 6, and protective layer 9 for covering dielectric layer 8. Protective layer 9 includes base film 91 and aggregated particles 92 formed on base film 91. The aggregated particles 92 (metal oxide) of a number of aggregated MgO crystal particles has a ratio from 0.1 to 10 inclusive between the maximum intensity of photoluminescence at a wavelength ranging from 200 nm to less than 300 nm and the maximum intensity of photoluminescence at a wavelength ranging from 300 nm to less than 500 nm. Furthermore, the aggregated particles 92 (metal oxide) contains aluminum (Al) from 50 ppm to 200 ppm inclusive in terms of weight concentration, and fluorine (F) from 150 ppm to 600 ppm inclusive in terms of weight concentration.

This configuration can suppress the increase in voltage required for discharge while reducing address discharge errors.

It is to be noted that a case of using MgO crystal particles as metal oxide crystal particles 92a has been described in the present embodiment.

However, the present invention is not limited to this case. Besides MgO, strontium oxide (SrO), calcium oxide (CaO), barium oxide (BaO), aluminum oxide (Al2O3), etc. can be used. In essence, the use of metal oxide crystal particles 92a that have a high ability to emit initial electrons can achieve a similar effect. Therefore, metal oxide crystal particles 92a are not limited to MgO. In addition, multiple types of metal oxide crystal particles can be also used.

Furthermore, a case of forming aggregated particles 92 on base film 91 has been described as an example in the present embodiment. However, the present invention is not limited to this case. More specifically, metal oxide crystal particles 92 may be, without being aggregated, formed as primary particles on base film 91.

It is to be noted that a case of the MgO film containing Al2O3 as the base layer has been described as an example in the present embodiment. However, the present invention is not limited to this case. Besides MgO, metal oxide films can be used, such as SrO, CaO, BaO, and Al2O3. In addition, films can be also used in which multiple types of metal oxides are mixed.

Furthermore, aggregates of metal oxide microparticles such as MgO, SrO, CaO, BaO, and Al2O3 can be used besides the metal oxide films. In addition, aggregates can be also used in which multiple types of metal oxide microparticles are mixed.

### INDUSTRIAL APPLICABILITY

The technique disclosed herein can achieve a PDP that is capable of suppressing the increase in discharge voltage while reducing address discharge errors. Therefore, the technique is useful for large-screen display devices, and the like.

### REFERENCE MARKS IN THE DRAWINGS

1 PDP

2 front plate

3 front glass substrate

4 scan electrode

4a, 5a black electrode

4b, 5b white electrode

5 sustain electrode

6 display electrode

7 black stripe

8 dielectric layer

9 protective layer

10 rear plate

11 rear glass substrate

12 address electrode

13 insulating layer

14 barrier rib

15 phosphor layer

16 discharge space

91 base film

92 aggregated particle

92a metal oxide crystal particle

1. A plasma display panel comprising:
a front plate; and
a rear plate provided to be opposed to the front plate,
wherein the front plate includes a display electrode, a dielectric layer for covering the display electrode, and a protective layer for covering the dielectric layer,
the protective layer includes a base layer and a plurality of metal oxide crystal particles formed on the base layer,
each of the metal oxide crystal particles has a ratio from 0.1 to 10 inclusive between a maximum intensity of photoluminescence at a wavelength ranging from 200 nm to less than 300 nm and a maximum intensity of photoluminescence at a wavelength ranging from 300 nm to less than 500 nm, and
each of the metal oxide crystal particles contains aluminum from 50 ppm to 200 ppm inclusive in terms of weight concentration, and fluorine from 150 ppm to 600 ppm inclusive in teens of weight concentration.

2. The plasma display panel according to claim 1,
wherein the metal oxide crystal particle has a ratio from 2 to 10 inclusive between the maximum intensity of photoluminescence at a wavelength ranging from 200 nm to less than 300 nm and the maximum intensity of photoluminescence at a wavelength ranging from 300 nm to less than 500 nm.

3. (canceled)

4. The plasma display panel according to claim 1, wherein the metal oxide crystal particles are configured to aggregated particles.

5. The plasma display panel according to claim 2, wherein the metal oxide crystal particles are configured to aggregated particles.

6. The plasma display panel according to claim 1, wherein the metal oxide crystal particle is a crystal particle of magnesium oxide.

7. The plasma display panel according to claim 2, wherein the metal oxide crystal particle is a crystal particle of magnesium oxide.

8. The plasma display panel according to claim 4, wherein the metal oxide crystal particle is a crystal particle of magnesium oxide.

9. The plasma display panel according to claim 5, wherein the metal oxide crystal particle is a crystal particle of magnesium oxide.
